(19) United States
(12) Patent Application Publication
(10) Pub. No.: US 2006/0175753 A1
(43) Pub. Date: Aug. 10, 2006

(54) Electronic game board

(76) Inventors: Peter MacIver, Huntington Beach, CA (US); James Keifer, Manhattan Beach, CA (US)

Correspondence Address: KOLISCH HARTWELL, P.C., 200 PACIFIC BUILDING, 520 SW YAMHILL STREET, PORTLAND, OR, 97204, US

(21) Appl. No.: 11/286,317

(22) Filed: Nov. 22, 2005

Related U.S. Application Data
(60) Provisional application No. 60/630,709, filed on Nov. 23, 2004.

(51) Int. Cl. A63F 3/00; A63F 13/00

(52) U.S. Cl. 273/237; 463/43

(57) ABSTRACT

An electronic game board is provided for use in a DVD gaming system including a DVD player where DVD media incorporating commands and audio visual content is accessed by the DVD player as part of game play. The electronic board may be used with play pieces and the board may be configured to determine the identity and location of a play piece on the electronic board and to wirelessly transmit location data to the DVD player. Play piece location information may be used by the DVD player to control game flow and select audio/visual content from the DVD media for display. The board may be configured to determine the location of finger contact on the board surface instead of play piece location. The board may also be configured to receive transmissions from the DVD player. The board may include command inputs such as buttons, switches or joysticks to be used as part of game play. The board may include a display for presenting information or pictures to players. The board may have overlays displaying different playing surfaces and playing spaces.

### CROSS-REFERENCE TO RELATED APPLICATIONS

This application claims priority under 35 U.S.C. 119(e) to U.S. Provisional Patent Application No. 60/630,709 entitled “NEW FORMAT LEARNING PLATFORM GAME,” filed Nov. 23, 2004, the disclosure of which is incorporated herein by reference, in its entirety and for all purposes.

### BACKGROUND

The present disclosure relates generally to video game remotes and devices used with DVD games, especially to electronic game boards that determine position of play pieces on the game board and transmit the piece position information to a DVD player as part of game play.

Examples of DVD games and/or electronic game boards are found in U.S. Patent Application Serial Nos. 20020193047; 20040063079; 20040140997; 20040214642 and 20050014563 and U.S. Pat. Nos. 5,661,470; 5,749,735; 5,823,782; 5,853,327; 5,855,503; 5,864,626; 5,991,693; 6,102,397; 6,104,334; 6,167,353; 6,190,174; 6,227,931; 6,361,396; 6,364,735; 6,443,796; 6,464,503; 6,471,565; 6,640,851; 6,650,870; 6,659,836; 6,692,358; 6,726,485; 6,729,881; 6,739,874 and 6,755,655 the disclosures of which are hereby incorporated by reference in their entirety for all purposes.

### SUMMARY

An interactive electronic game board is provided for use with a conventional DVD player configured to play DVD-Video discs as part of a DVD game system. The game board may include tokens or play pieces that are configured to be recognized by the board. The game board may incorporate functionality to locate the tokens when they are in contact with the board or in proximity to the board and communicate the location data to the DVD game system. The board may be further configured to identify individual game play pieces on the board surface. Play piece location information and control inputs by the player may be used by the DVD player to control game flow and select audio/visual content from the DVD media for display. The DVD game system may include a conventional DVD player, a television, an electronic game board and play pieces. The conventional DVD player may have limited memory and a limited number of ports for connecting peripheral components. The game board may also include display screens, speakers and control inputs such as buttons, knobs and joysticks.

The board may be configured to work with a plurality of overlays which may be used with the board to provide different indicia for game play. Different overlays may provide different games with different paths to be followed as play pieces move on the board. Overlays may provide spaces for play pieces to interact such as in a chess game. The board may have the capability to receive signals from other game system components with information related to game play. The board may have displays including video screens or speakers to present information to the players from the game system.

The electronic game board may be compatible with interactive games that combine the entertainment and educational content of conventional board games with the audiovisual content of video games. In particular, it may enhance play with interactive board games used in conjunction with conventional DVD players that play game related audiovisual content. These interactive games typically employ conventional DVD remote control units to interact with the audiovisual portion of the game. Due to the video game aspect of these DVD-based interactive games, they are particularly appealing to children, making them useful for presenting educationally-based content.

However, conventional DVD remote controls may have a large number of buttons and a significant degree of complexity, thereby making it difficult for a young child to interact with the audiovisual portion of the game during game play. Conventional DVD remote controls may also be limited in the quality of interactions possible with the DVD game. Therefore, a need exists for an interactive game which includes a game board played in conjunction with conventional DVD players where the game board may assume DVD remote functions during game play. The present electronic board is particularly useful for end users of video games, when coupled with video game software using interactive programming routines configured for board game play.

Because DVD game systems utilize a standard DVD player, a user who has already purchased and set up such a DVD player may play games without having to purchase a separate gaming console or connect additional equipment to the user's television, which may not have the appropriate inputs for connecting such equipment. This feature of the DVD gaming system may be advantageous to game developers and retailers, because more individuals have access to DVD players than to proprietary game consoles. Thus, games played on a DVD player and remote devices associated with it may appeal to a broader demographic, including individuals who may be unable to, or do not desire to, play games on proprietary gaming consoles.

The advantages of the present invention will be understood more readily after a consideration of the drawings and the Detailed Description.

### BRIEF DESCRIPTION OF THE DRAWINGS

FIG. 1 is a perspective view of a game system with a DVD player, DVD media, a television, an electronic game board and play pieces associated with the game board.

FIG. 2 is a block diagram of the game system of FIG. 1 illustrating transmissions between a game board and a DVD player and the relation of functional components including an electronic game board, a DVD player, a television and a play piece.

FIG. 3 is a perspective view of an electronic board showing an overlay and electronic components including a sensor array.

FIG. 4 is a cross sectional perspective view of the play surface of an electronic game board of FIG. 1 showing a play piece including an identifier and sensors implemented using radio frequency id tags and readers.

FIG. 5 is a cross sectional perspective view of the playing surface of an electronic game board of FIG. 1 showing a play piece including an identifier and sensors implemented using resonant frequency circuits.

FIG. 6 is a flow chart of the implementation of a game with an electronic board and two way communications between the electronic board and the DVD player.

### DETAILED DESCRIPTION

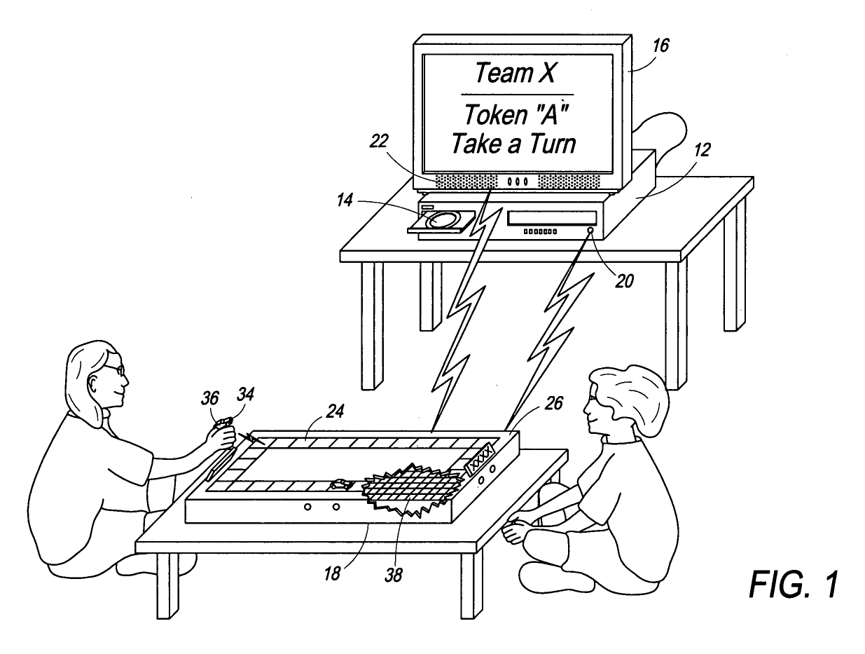

Referring to FIG. 1, a game system 10 is shown including a DVD player 12, DVD media 14, a television 16, and an electronic board 18. DVD player 12 includes an LED sensor 20. Television 16 includes a speaker 22. Game system 10 may include play spaces 24 displayed on an overlay 26. Electronic board 18 may include LED 32 (not shown) configured to operate with LED sensor 20, transferring commands and data to DVD player 12. Electronic board 18 may include play piece 34 with identifier 36 and detector circuit, sensor or sensor array 38. Sensor array 38 in this example is internal to board 18 and is shown in cutaway.

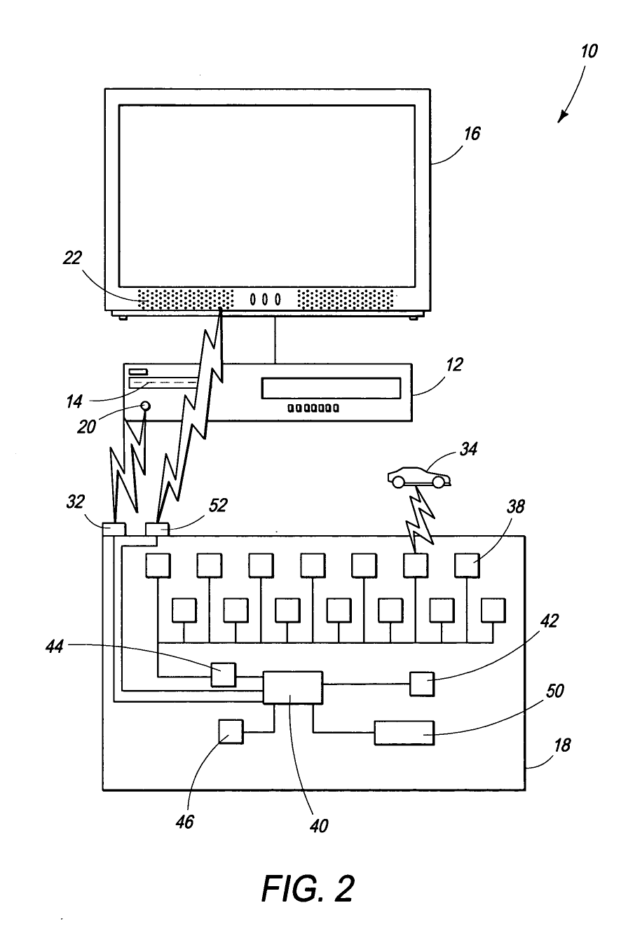

Referring to FIG. 2, a block diagram of game system 10 similar to FIG. 1 is shown. Similar numbering to FIG. 1 is used here and in all further figures for clarity. Game system 10 again includes DVD player 12, television 16, electronic board 18, LED sensor 20, LED 32, play piece 34, a plurality of sensors 38 forming a sensor array, as well as processor 40, memory 42, sensor controller 44, and remote control configuration media or game cartridge 46. Game system 10 may be configured to communicate data and commands from electronic board 18 to DVD player 12.

Game system 10 is used to play video games generated from programming commands and clips contained on DVD media 14. DVD player 12 accesses DVD media 14 and shows scenes, sounds and activities on television 16. Players may move play pieces 34 on electronic board 18 as part of game play. Play piece movement and location information may be detected by board 18 and transmitted to DVD player 12. DVD player 12 may control game flow and select clips and data from DVD media 14 based on the transmitted information as part of game play. DVD player 12 may have limited memory and be substantially configured to access DVD media 14 to display on television 16. DVD player 12 may have a limited number of ports for connecting to peripheral equipment.

Electronic board 18 may have functionality to detect the position of play pieces 34 in contact with board 18. Electronic board 18 may identify individual play pieces. Electronic board 18 may have a play surface with identifier sensors 38 proximate to the play surface. There are many techniques and technologies known in the art for locating objects with sensors. In a preferred example, identifier 36 may be a magnet or other component with physical properties that allow its presence to be determined by sensors 38. Sensors 38 may include a reed switch that may be activated by the magnetic field of play piece identifier 36. Alternately, sensors 38 may be physical switches such as a button. Moving play piece 34 to a play space 24 may press a button and close a circuit.

Other methods may be used to determine position of play pieces 34 on board 18. Sensors 38 may comprise a pair of conductors that define a capacitor. Identifier 36 may comprise a conductor with properties that cause the capacitance to vary such that sensor controller 44 may discern the physical property associated with the conductor and determine play piece location as it scans through the sensor array. Play piece 34 may have a pin with identifier 36 in the pin. The pin may be inserted through board 18 and be in proximity to sensors 38 below the board play surface. Identifier pin 36 may function to interrupt a light beam in sensors 38. Mass, light, or any other detectable physical property may be utilized to determine play piece 34 position.

Sensor controller or interface 44 may activate sensors 38 individually and/or sequentially and process the signals returned by the sensors. Controller 44 may scan sensors 38 periodically to locate individual play pieces 34. Sensors 38 may emit electromagnetic radiation which charges the identifier circuit 36. Sensors 38 not in proximity to any play piece 34 may return no digital identity signal. Alternate configurations of sensors 38 and identifiers 36 using more complex configurations and circuits are described below.

The location of a play piece 34 may be determined using the relative response of several sensors 38. For example, a play piece 34 located equidistant from 4 sensors 38 may result in a signal that is equivalent from all four sensors 38. In some embodiments, individual sensors 38 may be located in conjunction with individual play spaces 24.

Sensor controller 44 may incorporate an analog to digital conversion functionality to allow analysis of analog waveforms by digital circuits. Sensor controller 44 may also include multiplexer capability to combine several inputs to controller 44 and select between the inputs or combine inputs into one output. Sensor controller 44 may control the function of sensor array 38 and control scanning and sequential activation of circuits. Sensor controller 44 may be controlled in whole or in part by processor 40. Sensor controller 44 may transmit information to processor 40.

Memory 42 in electronic board 18 may be an IC chip, DIMM modules, a hard drive, removable media such as CDs or DVDs or a combination of in-circuit devices and readable media. Memory 42 may be associated with game cartridge 46. Game cartridge 46 may be an application specific integrated circuit (ASIC), an IC chip, memory board, a smart card, a cartridge, a CD ROM, a DVD-ROM, or any other media containing information.

Each play space 24 or command input may be mapped by the information stored on game cartridge 46 to correspond to different signals readable by a conventional DVD player, such as “Up,” “Down,” “Rewind,” “Fast Forward,” “Enter,” and “Menu” signals, or signals that direct DVD player 24 to play a specific scene or set of scenes contained on DVD game medium 14. Processor 40 may utilize the information on game cartridge 46 to control the type of game signal transmitted when a specific game space or user input is used. In some embodiments, the game cartridge 46 may include an integrated processor/controller.

Game cartridge 46 may customize the configuration of game board 18 to play specific games or to adapt game board 18 to work with a specific overlay. For example, game cartridge 46 may customize sensor array 38 to optimally operate with overlay 26 by turning off sensors 38 not proximate to play spaces 34. Alternately, game cartridge 46 may determine what signals are sent to DVD player 12. The same player piece location signal from sensor array 38 may cause different signals to be transmitted to DVD player 12 for different games.

Game cartridge 46 may be separable from board 18. Game cartridge 46 may be located in overlay 26.

Each game may have a defined set of play spaces 24 where play pieces 34 may be placed during play. Each possible location for a play piece 34 in the game will have a characteristic signal response from sensor array 38. Game cartridge 46 may determine which sensor array signals are mapped or indexed to which transmitted signals. DVD media 14 may contain programs to recognize play piece position from the transmitted signals. The transmitted signals containing play piece location data may be used by DVD player 12 to control game flow and select clips from DVD media 14.

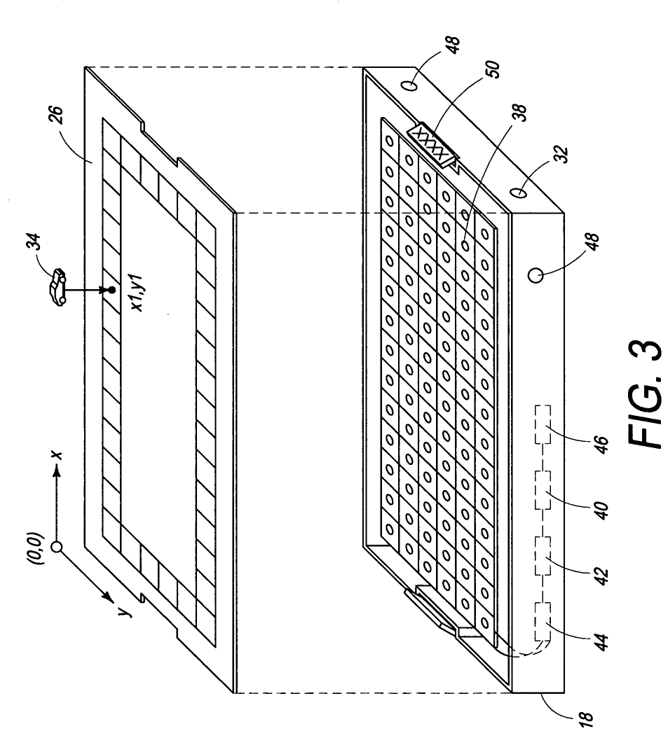

Referring to FIG. 3, a game board 18 is shown with an overlay 26 for playing a specific game. Similar numbering to previous figures is used for clarity and hidden or internal components are indicated with dashed lines. Board 18 again includes overlay 26, LED 32, sensors 38, processor 40, memory 42, sensor controller 44, game cartridge 46, command input 48 and display 50. Each location on game board 18 may correspond to an X, Y game board coordinate within a Cartesian coordinate system, where game board coordinates (0, 0) are arbitrarily shown in FIG. 3 as being in the upper left hand corner of game board 18. An array of sensors 38 may be located below the game board play surface at some or all of X, Y game board coordinates. Each of sensors 38 may be configured to detect a property of a game piece, such as magnetism, mass, light, or any other detectable property, and enable LED 32 to transmit a game signal to DVD player 12. For example, a sensor 38 configured to detect magnetism may be located below game board coordinate X1Y1. When magnetic play piece 34 is placed on game board coordinate X1Y1, sensor 38 located below game board coordinate X1Y1 may detect the magnet and enable LED 32 to send a game signal to DVD player 12. Sensors 38 may be located anywhere they are functionally able to detect play piece 34. Sensors 38 may be located below, in or above the play surface or in overlay 26.

In an alternate configuration, overlay 26 is an active component and operatively connects to board 18. Sensors 38 may be a component of overlay 26 and signals from sensors 38 may be transmitted through a connector to reach sensor controller 44. Play piece 34 with identifier 36 placed on overlay 26 produces a signal from sensors 38 located in overlay 26. When overlay 26 is replaced to play a different game, the connectors interconnecting overlay 26 to game board 18 are disengaged. New overlay 26 is placed on game board 18 and the new connectors engaged. Overlay 26 may have memory or logic circuitry as part of overlay 26 to provide game specific commands or data to game system 10. Overlay 26 may be separable from board 18 or overlay 26 may be a fixed part of board 18.

Play piece location data determined by sensor controller 44 may be transmitted to processor 40 and stored in memory 42. Play piece location information may be communicated to DVD player 12 through LED 32 and LED sensor 20. Game cartridge 46 may determine which commands and data are transmitted by LED 32 based on signals from sensor array 38. The transmitted information may be used by DVD player 12 to select digital material from DVD media 14 for presentation at television 16. The transmitted information may be commands to reconfigure DVD player 12 as part of game play.

Sensors 38 may be grouped into a plurality of regions based on their functional association with DVD player 12. Specifically, each group of sensors 38 may be mapped by remote control configuration media and universal remote circuitry and/or game cartridge 46 to correspond to a different signal readable by a conventional DVD player, such as “Up,” “Down,” “Rewind,” “Fast Forward,” “Enter,” and “Menu” signals, or signals that direct DVD player 12 to play a specific scene or set of scenes contained on DVD game media 14. When any sensor 38 within a group of sensors detects a play piece 34 with a property it is configured to detect, it may enable LED 32 to transmit a signal to DVD player 12. The signal to DVD player 12 may comprise a plurality of conventional signals such as “Up/Down/Rewind” sequentially.

Alternatively, electronic board 18 may not be associated with play pieces 34. Electronic board 18 may register finger contact on board 18 so that a player, instead of moving a play piece 34, contacts play spaces 24 with their finger. Sensors 38 may generate an electrical signal in response to the finger contact on play space 24 that is stored in memory 42 or transmitted to DVD player 12. Board 18 may respond to the finger contact by lighting up play space 24 or making a sound. Several lights may be collocated on a single play space 24 so that two teams can register simultaneous touch or presence in a single play space 24. Board 18 may have different colors of lights or different sounds for different players. Board 18, overlay 26 and sensors 38 may function as a touch screen.

Referring again to FIG. 3, board overlay 26 may be an expanse made of cardboard, plastic, shatterproof glass, or any other suitable material, and may define a plurality of locations, such as play spaces 24. Overlay 26 may either be planar, contoured or varied in shape, and may be detachable from board 18. The detachable expanse may include graphics corresponding to the theme of the game it is associated with to define play spaces 24. For example, in a game where the game players control characters to visit different locations, the graphics may show a map, where each defined game location is associated with a different play space 24.

It should be appreciated that a plurality of game board overlays 26 may be configured such that a user may change game board surfaces to play different games contained on different game media. Thus, when a user purchases a new game, it may include a game medium containing software for the new game, such as a DVD disk, and a new game board overlay 26. Removable media for electronic board memory 42 and game cartridge 46 may also be included. A new game purchase may include new play pieces 34.

Electronic board 18 may have functionality to receive signals from DVD player 12. Referring again to FIG. 2, a block diagram of game system 10 is shown with a microphone 52 to receive tone signals emitted by television 16 and speaker 22. Electronic game board 18 may be able to receive signals from DVD player 12 through television 16 and speaker 22. Preferably, DVD media 14 generates a tone signal at television 16 to communicate to electronic game board 18 as part of game execution. The tone signal may be received by electronic game board microphone 52 and decoded at processor 40.

Data received through tone based signals may be used to configure electronic game board 18. For example, data based on the tone signals may be shown on display 50. Alternately, tone signals may modify the generation or indexing of commands sent to DVD player 12. Tone based data may be stored in memory.

The commands sent by DVD player 12 and television 16 may be coded so that only one of several remote game devices being used simultaneously will respond to the signal. This allows a single user to get specific game play information or commands. However, other signals may also be coded more generally, so that all the players may get the same information displayed on electronic game board 18.

In an alternate configuration, game board 18 may detect visual light flashes or radio signals generated by components attached to DVD player 12 such as television 16 or other attached components rather than tone based signals.

The game may utilize only one remote game device for all the players or the game may utilize electronic board 18 and a handheld remote game device. Tones from speaker 22 may be decoded by processor 40 to commands or data that is shown on display 50 or that is stored in memory 42. Data transmitted from DVD player 12 may be used in conjunction with data from sensor controller 44. Other methods than tones may be used to transmit data to board 18 such as radio communications or infrared communication.

Digital commands and audio/visual material stored on DVD media 14 may utilize the minimal memory of DVD player 12. Although the capacity of DVD players to store information may be extremely limited as compared with a traditional gaming console, such memory storage may be used to hold data corresponding to one or more game variables, which may be used to control game play. In contrast to standard video games that require proprietary game consoles to play proprietary media, DVD player 12 does not need to be specially configured to play games stored on DVD media 14. Rather, the scripts stored on DVD media 14 may instruct DVD player 12 to store game variables in its onboard memory. The commands stored on DVD media 14 may also instruct DVD player 12 to implement logical decisions based on the values of the game variables.

Command input 48 may be used as part of game play. Input 48 may be used to indicate the completion of an activity or to indicate a correct or incorrect answer. Input 48 may be used to select or move an object on the screen. Command input 48 may be a button, slider, toggle switch, joystick, keypad or keyboard or any other input tool. Command input 48 may comprise a combination of different types of inputs.

To facilitate the use of electronic game board 18 with a variety of different DVD players, game board 18 may include universal remote control circuitry, which allows LED 32 to be programmed to communicate with a variety of different DVD players. LED 32 may be programmed by entering a code corresponding to a particular DVD player. Board 18 may be programmed by directing a signal from another remote to an optional signal detector of the DVD game remote. LED 32 may additionally or alternatively be programmed by running an automatic detection query in which remote control game board 18 transmits different signals until a signal corresponding to a particular DVD player is found.

Board 18 may have further capabilities such as generating random numbers to simulate rolls of dice. Board 18 may accept inputs from the players at command input 48 as to the next player or whether an answer is correct. Board 18 may show information on display 50 such as dice roll results. Board 18 may incorporate capabilities associated with a remote game device such as receiving information from other components of game system 10 that is subsequently shown on board display 50. Board 18 may instead be used in association with another remote game device or a DVD remote.

Identifier 36 may be a circuit with electronic components. In one example of the invention, identifier 36 is a radio frequency identifier tag (RFID) and identifier sensor 38 is a radio frequency identifier tag reader. An RFID tag stores a serial number associated with play piece 34 in a microchip that is attached to an antenna. The reader sends out electromagnetic waves. The tag antenna is tuned to receive these waves. A passive RFID tag draws power from a field created by the reader and uses it to power the microchip's circuits. The chip then modulates the signal that the tag sends back to the reader and the reader converts the modulated signal into digital data.

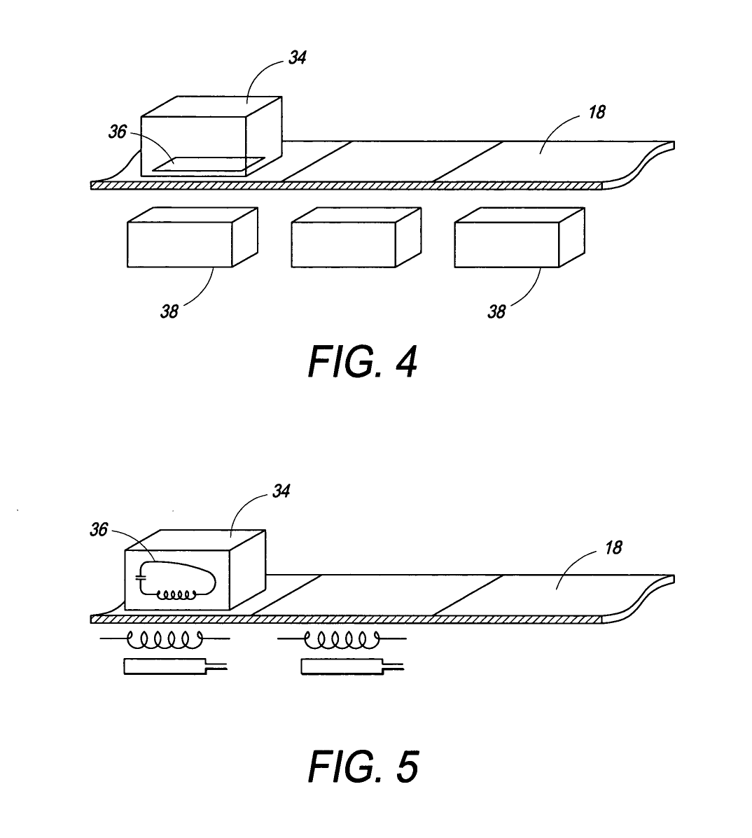

Referring to FIGS. 2 and 4, a block diagram of the functionality board 18 with play piece identifier 36 and identifier sensors 38 is shown, implemented as an RFID tag and RFID reader. Similar numbering to previous figures is used here for clarity. RFID identifier 36 may be located internally to play piece 34 and may be located at a bottom face which will be proximate to the play surface of board 18. Play piece 34 may include shielding to limit electromagnetic radiation emission. RFID sensors 38 may be disposed proximate to the play surface of board 18. RFID sensors 38 may be comprised of an array of sensors configured to differentiate all play spaces 24 associated with the play surface of board 18.

In an alternate configuration, identifier 36 may be a circuit with a characteristic frequency. Referring to FIGS. 2 and 5, a block diagram of game system 10 implemented with resonant frequency identifiers 36 and sensors 38 is shown. Similar numbering to previous figures is used for clarity. Identifier 36 may include a capacitor and coil configured to have a resonant frequency determined by the electrical characteristics associated with the components. Sensors 38 may include an exciter coil and an antenna. When the exciter coil is activated, identifier 36 in play piece 34 is energized. Sensor controller 44 antenna will receive the electromagnetic radiation associated with the exciter coil and identifier circuit 36. A signal from an exciter coil proximate to an identifier circuit 36 will be substantially different from the waveform generated by an exciter coil not proximate to an identifier circuit.

Electronic game board 18 described here is an example. Board 18 can have all or fewer of the features or functionality described and still fall within the scope of this disclosure

Referring to FIG. 6, a flow chart 100 of game play in a DVD game including an electronic board 18 is shown. In this example, game board 18 includes functionality to communicate to DVD player 12 and receive information through television 16 which is shown on game board display 50. Different kinds of game activities on DVD media 14 are associated with different play spaces in this example game. In box 102, players form teams and select play pieces 34. In box 104 game system 10 is configured as to number of teams, play piece identities and game play difficulty. In box 106, game system 10 displays a play piece 34 and team for the next turn. That team determines movement of play piece 34 by rolling dice or some other method defined in game play in box 108 and moves play piece 34 in box 110. Game board 18 sends the play piece identification and location information to DVD player 12 in box 112. Using play piece 34 location information, the game may select a random clip from the group of clips corresponding to the activity type associated with the play space 24 in box 114. In box 116, game system 10 displays an activity or challenge on television 16. If required, the game sends data to board 18 in box 118. The data may be displayed so select players can access information for the other players to guess. The player enters or selects an answer with command input 48 at box 120. The loop may continue until activity is complete. Once an answer is entered, game system 10 computes and displays a score on television 16 in box 122. If the game is over in box 124, a final score is displayed on television 16 with appropriate graphics for the winning team in box 126. If the game is not over, the game loops back to box 106 and game play continues.

These steps are an example of one embodiment of this invention. A game may have more or fewer steps or have different steps and still fall within the scope of this disclosure.

In some configurations, game board 18 can determine play piece identity. In an example of game play with game board 18, game board 18 recognizes individual tokens during game play and DVD player 12 stores play piece 34 location information in memory. Game board 18 in this example can recognize the play pieces A and B. During game play, teams or players may be selected or indicated as currently having a turn by DVD player 12. When indicated as currently having a turn, play pieces 34 may be moved or the team engages in activities selected from DVD media 14 by DVD player 12.

Play piece A in this example may be moved during the turn of team X to a space identified as 32 by the game system 10. Game board 18 may then transmit this data to DVD player 12 as “piece A at position 32.” DVD player 12 may save the received data as “Piece A at position 32.” DVD player 12 may also register that play piece A belongs to team X and register points for team X or select appropriate clips from DVD media 14.

In a contrasting example of game board 18, identification of individual play pieces may not be required. While a specific player or team is indicated as having a turn, all inputs at board 18 associated with play piece movement or other input at control 48 may be assigned to that player or team regardless of which play piece 34 is actually moved or which specific input is activated. In this example, DVD player 12 indicates team X as next in turn rotation and displays the team selection to all players. Play piece A is moved while team X is indicated. Game board 18 may register that a play piece has moved to location 32 and transmit only “32” to DVD player 12. DVD player 12 indexes 32 to team X and play piece A as the indicated team and may save the data as “Piece A at position 32.” DVD player 12 may then register points for team X or select appropriate clips from DVD media 14. This may provide a less complex and less expensive implementation of game board 18.

Because DVD game system 10 utilizes a DVD player 12, a user who has already purchased and set up such a DVD player may play games without having to purchase a separate gaming console or connect additional equipment to the user's television, which may not have the appropriate inputs for connecting such equipment. This feature of DVD gaming system 10 may be advantageous to game developers and retailers, because more individuals have access to DVD players than to proprietary game consoles. Thus, games played on a DVD player may appeal to a broader demographic, including individuals who may be unable to, or do not desire to, play games on proprietary gaming consoles.

It is believed that this disclosure encompasses multiple distinct inventions with independent utility. While each of these inventions has been described in its best mode, numerous variations are contemplated. All novel and non-obvious combinations and subcombinations of the described and/or illustrated elements, features, functions, and properties should be recognized as being included within the scope of this disclosure. Applicant reserves the right to claim one or more of the inventions in any application related to this disclosure. Where the disclosure or claims recite “a,” “a first,” or “another” element, or the equivalent thereof, they should be interpreted to include one or more such elements, neither requiring nor excluding two or more such elements.

We claim:

1. An electronic game board set comprising:
a housing defining a play surface;
a processor supported in the housing;
inputs supported in the housing and operably connected to the processor including:
sensors distributed in an array about the play surface;
a cartridge port adapted to receive a game cartridge; and
a microphone for receiving tone based data;
an LED operably connected to the processor; and
an overlay including indicia defining play spaces, the overlay being adapted to cover at least a portion of the play surface;
wherein a cartridge compatible with the cartridge port configures the processor to transmit sensor array data from the LED.

2. The electronic game board set of claim 1 where the sensor array detects the location of a play piece positioned on the play surface.

3. The electronic game board set of claim 2 where the play piece has a detectable identity, and wherein the sensor array further determines the identity of the play piece.

4. The electronic game board set of claim 2 where the sensor array detects the location of the play pieces by detecting a physical property of the play piece.

5. The electronic game board set of claim 1 where the cartridge for the port includes memory or logic.

6. The electronic game board set of claim 1 where the overlay includes the sensor array.

7. The electronic game board set of claim 1 where the microphone receives audio transmissions originating from an external device and the processor is responsive to a code contained in received audio transmissions.

8. The electronic game board set of claim 1 where the processor is adapted to produce sensor data from signals received from the sensor array, and to transmit the sensor data using the LED.

9. An electronic game board set comprising:
an electronic game board including:
a detector circuit to detect the location of a first play piece and a second play piece on the game board;
an LED; and
a plurality of play pieces including the first play piece and the second play piece;
a game cartridge which configures the game board to transmit using the LED location data corresponding to detected locations of the play pieces.

10. The electronic game board set of claim 9 where the first play piece and the second play piece have detectable identities and the detector circuit further determines play piece identity.

11. The electronic game board set of claim 9 further comprising a separable overlay operably connected to the game board.

12. The electronic game board set of claim 9 where the game cartridge is separable and determines mapping of detector circuit input to transmitted signals.

13. The electronic game board set of claim 9 further comprising a microphone to receive tone based data.

14. The electronic game board set of claim 9 where the game cartridge includes memory or logic circuits.

15. The electronic game board of claim 9 where the electronic board determines the play piece position by detecting physical properties.

16. A game system comprising:
a DVD player;
an overlay defining play piece spaces;
a plurality of play pieces;
a sensor array configured to detect the position of play pieces proximate to the array with the overlay positioned on the array;
a game board including a transmitter that sends detected play piece position data to the DVD player; and
a game cartridge that configures the electronic game board to transmit position data.

17. The game system of claim 16 where the electronic board is further configured to identify individual play pieces.

18. The game system of claim 16 where the DVD player is configured to generate tone based data and the system further comprises a microphone that receives the tone based data.

19. The game system of claim 16 where the electronic board displays received data on a screen.

20. The game system of claim 16 where the electronic board determines the play piece position by detecting physical properties.

21. The game system of claim 16 where the electronic board determines the play piece position by receiving a digital code.

22. The game system of claim 16 where the electronic board determines the play piece position by closing a switch or blocking a light beam.

23. The game system of claim 16 where the play pieces include electromagnetic shielding.

24. The game system of claim 16 where the electronic board includes a plurality of buttons for determining play piece position.

25. A game method comprising the steps of:
sensing the location of a play piece on a game board;
transmitting location data representing the sensed location of a play piece and configuring the transmission using a game specific cartridge;
receiving location data at a DVD player; and
selecting clips from DVD media based at least in part on the received data.

26. The game method of claim 25 further comprising the steps of:
generating tones;
receiving the tones at the game board; and
displaying data determined by received tones on a screen.

27. The game method of claim 25 further comprising the steps of:
identifying a play piece for data indexing; and
indexing location data to the play piece at the DVD player.

28. The game method of claim 25 where the location data includes the identity of a play piece and the data is saved on the DVD player.

29. The game method of claim 25 where the sensor is activated by detecting physical properties.

30. The game method of claim 25 where the sensor is activated by receiving a digital code.

31. The game method of claim 25 where the sensor is a button.

32. The game method of claim 25 where the sensor is activated by closing a switch or blocking a light beam.

33. The game method of claim 25 where indexing is determined by a game cartridge.
